(19) United States
(12) Patent Application Publication
(10) Pub. No.: US 2020/0407547 A1
(43) Pub. Date: Dec. 31, 2020

(54) ITEM FOR FOOD CONTACT APPLICATIONS

(71) Applicant: Covestro Intellectual Property GmbH & Co. KG, Leverkusen (DE)

(72) Inventors: Andreas Seidel, Dormagen (DE); Uli Franz, Solingen (DE); Achim Gustorf, Bergisch Gladbach (DE); David Harrison, Odenthal-Voiswinkel (DE)

(21) Appl. No.: 16/975,245

(22) PCT Filed: Mar. 4, 2019
(86) PCT No.: PCT/EP2019/055244

§ 371 Date: Aug. 24, 2020

(30) Foreign Application Priority Data
Mar. 7, 2018 (EP) 18160463.8

(51) Int. Cl. C08L 55/02; C08L 69/00; A23G 1/22

(52) U.S. Cl. CPC C08L 55/02; C08L 2203/30; A23G 1/226; C08L 69/00

(57) ABSTRACT

The invention relates to an item selected from the group consisting of containers for packaging, serving, storing and/or transporting fats, oils and fatty foods, tools for the consumption of fats, oils and fatty foods, tools for producing, preparing, shaping and processing fats, oils and fatty foods, as well as parts of machines for producing, preparing, shaping and processing fats, oils and fatty foods, including a moulded body consisting of a particular thermoplastic polycarbonate composition, wherein the moulded body is in direct contact with the fats, oils and fatty foods during the use of the item. The invention also relates to the use of the specific thermoplastic polycarbonate composition for producing the moulded body as a part of the item, the use of the item for transporting, packaging, storing, handling, producing, preparing, processing and shaping fats, oils and fatty foods, and a method for producing a shaped fat or fatty food.

The present invention relates to articles selected from containers for packaging, for serving, for storage and/or for transport of fats, oils or fat-containing foodstuffs, tools for consumption of fats, oils or fat-containing foodstuffs, tools for production, preparation, shaping and processing of fats, oils or fat-containing foodstuffs and parts of machines for production, preparation, shaping and processing of fats, oils or fat-containing foodstuffs.

An article in the context of the present application contains or consists of a molded body consisting of a special thermoplastic composition. In the articles the molded bodies may be partially covered with other materials or joined to other materials, for example in the form of handles or coatings. When the article is used as intended the molded body is in direct contact with the fats, oils or fat-containing foodstuffs.

The invention also relates to the use of the thermoplastic composition to produce the molded bodies as part of the articles and to the use of the articles for transport, packaging, storage, treatment, production, preparation, processing and molding of the fats, oils or fat-containing foodstuffs.

The invention further relates to a process for producing a molded fat-containing foodstuff.

Polycarbonate has proven advantageous in many ways as a material for thermoplastic production of articles for food contact applications. Thus for example drinks bottles, crockery, drinking vessels, cutlery, bowls, pots and other types of containers, trays and also chocolate molds are made from polycarbonate. The advantage of polymeric thermoplastics compared to other materials likewise used in these fields of application, for example glass, porcelain or metal, is in particular that of better fracture resistance and lower weight. Compared to thermosets, thermoplastics have particular advantages in terms of simpler mass production and in terms of material recycling. Polycarbonate is suitable as a polymeric thermoplastic in comparison to other thermoplastic especially due to its high heat resistance and its advantageous balance of stiffness, toughness and hardness of polycarbonate. However, one disadvantage is its stress cracking resistance, especially in contact with fats and oils or fat-containing foodstuffs, which is insufficient for some applications. This can lead to damage to the articles employed as packaging, for serving, for storage and/or for transport of fats, oils or fat-containing foodstuffs, as tools for consumption of fats, oils or fat-containing foodstuffs, as tools for production, preparation, shaping and processing of fats, oils or fat-containing foodstuffs and as parts of machines for production, preparation, shaping and processing of fats, oils or fat-containing foodstuffs.

The problem addressed is accordingly that of providing articles selected from containers for packaging, for serving, for storage and/or for transport of fats, oils or fat-containing foodstuffs, tools for consumption of fats, oils or fat-containing foodstuffs, tools for production, preparation, shaping and processing of foodstuffs and parts of machines for production, preparation, shaping and processing of fats, oils or fat-containing foodstuffs containing or consisting of molded bodies, wherein the molded bodies consist of thermoplastic compositions having a balance of melt flowability and stress cracking resistance in contact with fats, oils and fat-containing foodstuffs that is improved compared to pure polycarbonate.

The articles shall ideally have a similar profile of properties in terms of toughness, stiffness, heat resistance and hydrolysis resistance compared to articles made of pure polycarbonate in order that the use and handling established for articles made of polycarbonate may be retained as far as possible.

One special form of such articles according to the invention containing or consisting of molded bodies, wherein the molded bodies consist of thermoplastic compositions, are molds for molding fats or fat-containing foodstuffs into which the foodstuff is filled in heated and thus molten form, is subsequently solidified by cooling and after cooling has assumed the specified shape. One example of such molds are chocolate molds which are often produced from thermoplastics, particularly often from polycarbonate.

EP 0 429 969 B1 discloses a coolable chocolate mold made of plastic.

DE-PS 1 283 661 discloses a metal-reinforced chocolate mold made of plastic.

DE-OS 18 06 244 discloses a process for molding and packaging chocolate coating compositions or couverture chocolates and a mold made of plasticizer-free thermoplastic such as polystyrene and polypropylene for performing this process.

EP 0 531 651 A3 discloses a hinged mold for the production of chocolate hollow bodies, wherein the hinged mold consists of two halves each consisting of a frame, a movable frame half and two mold inserts, wherein the mold inserts are interchangeably accommodated in the frame and consist of a thermoplastic. Polypropylene, polycarbonate and polyamide are disclosed as suitable plastics.

The Internet site http://www.chocolat-chocolat.com/home/chocolate-molds/index.html as at Dec. 23, 2017 discloses chocolate molds made of polycarbonate.

Prior art chocolate molds produced from polycarbonate have a limited product lifetime as a result of the inadequate stress cracking resistance of this material in contact with the fats of the cocoa butter, especially at the elevated processing temperature of the liquid chocolate.

Furthermore, the chocolate moldings produced in molds made of polycarbonate generally have a sometimes unwanted glossy surface texture since the polycarbonate itself has a high-gloss surface appearance. The achievement of a matte appearance of the chocolate molding via a surface texture of the chocolate mold in the sense of a fine graining for example often leads to problems during demolding of the chocolate molding and thus constitutes a rather unsuitable technical solution for achieving the desired surface appearance of the chocolate molding.

A further disadvantage of the use of polycarbonate for producing chocolate molds is the comparatively poor melt flowability of the thermoplastic molding compounds. In the production of the chocolate molds this limits the achievable flow lengths or wall thicknesses and the formation of delicate structures and finely textured surfaces of the chocolate mold. While this may be countered in known fashion in injection molding by increasing the processing temperature, such elevated processing temperatures generally result in molecular weight degradation and consequently in poorer mechanical properties of the chocolate molds, in particular in further impairment of stress cracking resistance of such molds in contact with fats and oils and fat-containing foodstuffs. Improving the melt flowability of the polycarbonate material by reducing its molecular weight is therefore not an option either.

It was therefore desirable to provide molds for producing molded fats or fat-containing foodstuffs, in particular chocolate molds, having a more matte surface, wherein in the production of the mold by injection molding an injection mold made of metal having a polished metal surface is employed and a thermoplastic composition having a balance of melt flowability and stress cracking resistance, especially in contact with fats and fat-containing foodstuffs, that is improved compared to the pure polycarbonate is employed and wherein the molded body thus fabricated from the thermoplastic composition has an inherently more matte surface appearance compared to the use of pure polycarbonate.

These molds shall ideally have a similar profile of properties in terms of toughness, stiffness, heat resistance and hydrolysis resistance compared to corresponding articles made of pure polycarbonate in order that the use and handling established for such molds made of polycarbonate may be retained as far as possible.

It is known that the flowability of polycarbonate molding compounds may also be improved by addition of polymeric blend partners. Thermoplastic molding compounds composed of polycarbonates and for example acrylonitrile butadiene styrene (ABS) polymers (PC/ABS blends) have long found manifold industrial use and show improved processability in injection molding compared to pure polycarbonate. Such compositions are described for example in DE-A 1 170 141. U.S. Pat. No. 4,526,926 specifically discloses PC/ABS blends based on ABS polymers produced in a bulk polymerization process which feature improved processability, good impact strength and heat resistance and a low gloss.

When adding blend partners to achieve the desired technical improvements the admixing of different polymers generally results in heterogeneous polymer blend systems. For such polymer blend systems those skilled in the art generally cannot make reliable predictions from the properties of the individual components about whether and how they will influence the quality of the foodstuffs in contact with molded bodies made from such blends.

“Quality of the foodstuff” is to be understood as meaning the constitution of the foodstuff, for example in terms of its haptics, its appearance (for example its color or its surface constitution), its flavor, its aroma and its pH.

A further problem addressed is accordingly that of providing inventive articles according to one of the abovementioned descriptions, wherein the articles containing or consisting of molded bodies made of thermoplastic compositions have the smallest possible influence, or particularly preferably no influence, on the constitution of the fat, oil or fat-containing foodstuff with which the molded bodies are in direct contact during use of the article, for example in terms of its haptics, its appearance (for example its color or its surface constitution), its flavor, its aroma and its pH.

These articles shall ideally have a similar profile of properties in terms of toughness, stiffness, heat resistance and hydrolysis resistance compared to articles made of pure polycarbonate in order that the use and handling established for articles made of polycarbonate may be retained as far as possible.

According to a specific problem addressed these articles shall be suitable for use in food contact applications in which the molded bodies when used as intended come into contact with fats, oils and fat-containing foodstuffs at temperatures of 0° C. to 100° C., particularly at 20° C. to 80° C., in particular at 30° C. to 70° C. It is therefore necessary for the above-described improvement in stress cracking resistance to be achieved in these temperature intervals. According to a further specific problem addressed the articles shall be suitable for contact with liquid chocolate and similar liquid cocoa-containing foodstuffs, in particular at temperatures of 30° C. to 70° C.

A further specific problem addressed is that of providing molds for fat-containing foodstuffs, in particular chocolate molds, made of thermoplastic compositions having a balance of melt flowability and stress cracking resistance in contact with fats, oils and fat-containing foodstuffs, in particular with liquid chocolate and similar liquid cocoa-containing foodstuffs, that is improved compared to pure polycarbonate and also having a reduced gloss. The foodstuffs processed in such molds are generally employed in the molding process in a temperature range from 20° C. to 80° C., particularly from 30° C. to 70° C. It is therefore necessary for the above-described improvement in stress cracking resistance to be achieved in these temperature intervals.

The articles according to the invention, the molded bodies contained therein and the thermoplastic compositions of which these molded bodies consist must naturally meet the regulatory requirements demanded of plastics, molded bodies and articles in the respective food contact application. These requirements vary by region and may change over time. They further depend on the relevant foodstuff and the type of application.

For example in the countries of the European Union the articles, the molded bodies present therein and the thermoplastic compositions of which these molded bodies consist must meet the regulatory requirements according to EU Commission Regulation 10/2011 of Jan. 14, 2011 concerning materials and objects made of plastic which are intended to come into contact with foodstuffs. According to Article 12 of the recited EU Regulation, this means for example that constituents must not pass from the molded bodies made of the thermoplastic compositions into food simulants in amounts of more than a total of 10 mg per dm² of the molded article surfaces coming into contact with the foodstuff. The food simulant to be used and the temperature and the duration of contact of the food simulant with the plastic body depend on the intended use and are intended to simulate said use in the best possible way.

According to the abovementioned regulatory requirements in countries of the European Union, depending on the food in questions suitable food simulants especially include representatives selected from the group consisting of a mixture of 10% by volume of ethanol in water, a mixture of 20% by volume of ethanol in water, a mixture of 50% by volume of ethanol in water, a mixture of 3% by weight of acetic acid in water, vegetable oil (for example olive oil or rapeseed oil), a mixture of 95% by volume of ethanol with 5% by volume of water and isooctane.

For plastic applications in contact with fats, oils or fat-containing foodstuffs, for example for chocolate molds, suitable food simulants especially include either vegetable oil (for example olive oil or rapeseed oil), a mixture of 95% by volume of ethanol with 5% by volume of water or isooctane.

In a simplified test method the media used as food simulants may also be analyzed for macroscopic physical properties such as transmission, haze, pH or conductivity after storage of samples of the thermoplastic compositions in the media for a certain period. A reduced transmission or a larger haze value for example indicates a migration of constituents from the sample into the food simulant. This makes it possible to compare different thermoplastic materials with one another in respect of their influence on the constitution of the fat, oil or fat-containing foodstuff with which molded bodies produced from these materials are in direct contact during use of articles containing such molded bodies.

It has now been found that, surprisingly, the problems addressed by the invention are solved by articles selected from the group consisting of containers for packaging, for serving, for storage and/or for transport of fats, oils or fat-containing foodstuffs, tools for consumption of fats, oils or fat-containing foodstuffs, tools for production, preparation, shaping and processing of fats, oils or fat-containing foodstuffs and parts of machines for production, preparation, shaping and processing of fats, oils or fat-containing foodstuffs containing or consisting of a molded body consisting of a thermoplastic composition, characterized in that the thermoplastic composition contains or consists of the following components:

A) aromatic polycarbonate,

B) rubber-modified vinyl (co)polymer composed of
B.1) 80% to 95% by weight, based on the rubber-modified vinyl (co)polymer B, of structural units derived from at least one vinyl monomer and
B.2) 5% to 20% by weight, based on the rubber-modified vinyl (co)polymer B, of one or more elastomeric graft substrates having glass transition temperatures <−50° C. and containing at least 50% by weight based on B.2 of structural units derived from 1,3-butadiene,
   wherein the rubber-modified vinyl (co)polymer B contains
   (i) a disperse phase consisting of
      (i.1) rubber particles grafted with vinyl (co)polymer composed of structural units of B.1 and
      (i.2) vinyl (co)polymer likewise composed of structural units of B.1 enclosed in the rubber particles as a separate disperse phase and
   (ii) a rubber-free vinyl (co)polymer matrix consisting of structural units of B.1 which is not bonded to the rubber particles and is not enclosed in these rubber particles,
   wherein the disperse phase of (i) has a median diameter D50 measured by ultracentrifugation of 0.3 to 2.0 μm,
C) optionally at least one further component selected from polymer additives and polymeric blend partners,

and wherein during use of the article the molded body is in direct contact with the fats, oils or fat-containing foodstuffs.

An article containing or consisting of molded bodies for food contact with fats, oils or fat-containing foodstuffs is therefore concerned. “For food contact” is to be understood as meaning that the molded bodies are suitable for direct food contact. To this end it is necessary from a regulatory standpoint, as described above, for the thermoplastic composition and the molded bodies and articles produced therefrom containing or consisting of the molded bodies to meet the regulatory requirements for materials and articles coming into contact with the relevant foodstuff according to the respective regional requirements. In a preferred embodiment each of the individual components A to C of the thermoplastic composition also meets these requirements.

In a preferred embodiment the components A to C of the thermoplastic composition, the thermoplastic compositions, the molded bodies and the articles produced therefrom containing or consisting of these molded bodies meet the regulatory requirements according to EU Commission Regulation 10/2011 of Jan. 14, 2011 concerning materials and objects made of plastic which are intended to come into contact with foodstuffs.

This means in particular that in this preferred embodiment all components A to C or, to the extent that the components A to C are polymers, all monomeric units from which these polymers are constructed and all additives (except dyes) intentionally used in these polymers are in principle permitted according to the European Union list of permitted monomers, other starting materials, macromolecules obtained by microbial fermentation, additives and auxiliaries in the production of plastics according to Appendix I of the abovementioned EU Regulation for food contact. The list in this Appendix I is expressly included in the disclosure content of the present application.

A preferred embodiment further provides for molded bodies produced from the thermoplastic compositions and also for molded bodies produced from each of the individual components A, B and from each individual optional polymeric single constituent of the component C that constituents must not pass therefrom into a food simulant in amounts of more than a total of 10 mg per dm² of the molded body surfaces coming into contact with this food simulant over 2 hours at 70° C., more preferably over 10 days at 40° C., wherein the food simulant is selected from the group consisting of vegetable oil (for example olive oil or rapeseed oil), a mixture of 95% by volume of ethanol with 5% by volume of water and isooctane. It is very particularly preferable when the food simulant is isooctane.

In a preferred embodiment the components A, B and optional polymeric constituents of the component C each contain a total of not more than 2000 ppm, particularly preferably not more than 1000 ppm, of residual monomers and, where solvents are used in the production process, of residual solvents.

The thermoplastic compositions preferably contain or consist of
30-90% by weight, more preferably 40-85% by weight, particularly preferably 50-80% by weight and very particularly preferably 60-75% by weight, of the component A,
10-70% by weight, more preferably 10-55% by weight, particularly preferably 15-45% by weight and very particularly preferably 24-39% by weight, of the component B,
0-20% by weight, more preferably 0.01-20% by weight, particularly preferably 0.05-5% by weight and very particularly preferably 0.1-1% by weight, of the component C.

If the compositions contain further components in addition to the components A, B and C these further components must likewise meet the regulatory requirements for contact with fats, oils or fat-containing foodstuffs.

In a preferred embodiment the compositions contain a total of at least 90% by weight, more preferably at least 95% by weight, and particularly preferably at least 99% by weight of the components A, B and C. In the most preferred embodiment the compositions consist only of the components A, B and C.

The molded bodies according to the invention are preferably suitable as means for transport, packaging, storage, treatment, production, processing and consumption of fat-containing foodstuffs. The content of fats in these foodstuffs is preferably at least 5% by weight, particularly preferably at least 10% by weight, more preferably at least 20% by weight, most preferably at least 30% by weight.

The molded bodies according to the invention are also suitable as means for transport, packaging, storage, treatment, production, processing and consumption of fats and oils.

The molded bodies according to the invention are preferably also suitable as a means for transport, packaging, storage, treatment, production, processing and consumption of fat-containing foodstuffs, fats and oils at a temperature of above 30° C., more preferably of 40° C. to 80° C., the foodstuffs thus having this relatively high temperature. Suitability is to be understood as meaning that even at these relatively high temperatures above 30° C., preferably of 40° C. to 80° C., the level of migration from the molded body into the foodstuff or into a food simulant remains acceptable.

The molded bodies according to the invention are for example a representative selected from the group containing, preferably consisting of, crockery, drinking vessels, cutlery, bowls, pots and other types of vessels, trays and molds for fat-containing foodstuffs.

In a further preferred embodiment the molded body according to the invention is a mold for fats and fat-containing foodstuffs.

In a further preferred embodiment the the molded body according to the invention is a chocolate mold.

The chocolate mold is used for example for production of slab chocolate, a chocolate bar, a praline or a chocolate hollow body such as for example a chocolate egg, a chocolate Santa or a chocolate rabbit.

The present invention further provides a process for producing a molded fat or fat-containing foodstuff, particularly preferably from chocolate and similar liquid cocoa-containing foodstuffs using the molds according to the invention.

In this process the foodstuff is initially heated to a temperature above its melting point/its melting temperature range and thus liquefied, then filled into the mold in molten form, subsequently cooled to a temperature below its melting point/its melting temperature range and thus solidified and finally demolded from the mold.

The present invention further provides for the use of thermoplastic compositions containing or consisting of the components A, B and C to produce molded bodies as part of articles selected from the group consisting of containers for packaging, for serving, for storage and/or for transport of fats, oils or fat-containing foodstuffs, tools for consumption of fats, oils or fat-containing foodstuffs, tools for production, preparation, shaping and processing of foodstuffs and parts of machines for production, preparation, shaping and processing of fats, oils or fat-containing foodstuffs.

Use for producing molds is preferred, use for producing molds for fats, oils and fat-containing foodstuffs is more preferred and use for producing chocolate molds is particularly preferred.

The present invention further provides for the use of the articles according to the invention for transport, packaging, storage, treatment, production, preparation, processing and shaping of fats, oils or fat-containing foodstuffs.

### Component A

An aromatic polycarbonate or a mixture of a plurality of aromatic polycarbonates is used as component A.

Aromatic polycarbonates of component A which are suitable according to the invention are known from the literature or may be produced by literature processes (for production of aromatic polycarbonates see, for example, Schnell, “Chemistry and Physics of Polycarbonates”, Interscience Publishers, 1964, and DE-AS 1 495 626, DE-A 2 232 877, DE-A 2 703 376, DE-A 2 714 544, DE-A 3 000 610, DE-A 3 832 396).

Aromatic polycarbonates are produced for example by reaction of diphenols with carbonyl halides, preferably phosgene and/or with aromatic diacarbonyl dihalides, preferably dihalides of benzenedicarboxylic acid, by the interfacial process, optionally using chain terminators, for example monophenols, and optionally using trifunctional or more than trifunctional branching agents, for example triphenols or tetraphenols. Production via a melt polymerization process by reaction of diphenols with diphenyl carbonate for example is likewise possible.

The diphenol used is preferably 2,2-bis(4-hydroxyphenyl)propane (bisphenol A).

The diphenols may be used individually or in the form of any desired mixtures. The diphenols are known from the literature or obtainable by processes known from the literature.

The chain terminators suitable for producing the thermoplastic, aromatic polycarbonates are for example phenol and p-tert-butylphenol. The chain terminators are employed in an amount of generally between 0.5 mol % and 10 mol % based on the molar sum of the diphenols employed in each case.

The thermoplastic, aromatic polycarbonates may be branched in a known manner, and preferably through incorporation of 0.05 to 2.0 mol %, based on the sum of the diphenols used, of trifunctional or more than trifunctional compounds, for example those having three or more phenolic groups.

Both homopolycarbonates and copolycarbonates may be suitable provided they meet the regulatory requirements for food contact applications.

In a preferred embodiment the aromatic polycarbonates suitable as component A have a weight-average molecular weight M_{W} (determined by gel permeation chromatography (GPC) in methylene chloride with a polycarbonate standard) of 20000 g/mol to 40000 g/mol, preferably of 22000 g/mol to 35000 g/mol, in particular of 24000 to 32000 g/mol.

In a preferred embodiment the aromatic polycarbonates suitable as component A contain oligomeric constituents having a molecular weight (determined by gel permeation chromatography (GPC) in methylene chloride with a polycarbonate standard) of less than 1000 Dalton in a proportion of not more than 2% by weight, more preferably not more than 1% by weight, particularly preferably not more than 0.5% by weight, most preferably not more than 0.2% by weight.

### Component B

Component B is selected from rubber-modified vinyl (co)polymers of
B.1) 80% to 95% by weight, preferably 83% to 93% by weight, more preferably 85% to 92% by weight, based on the rubber-modified vinyl (co)polymer B, of structural units derived from at least one vinyl monomer and
B.2) 5% to 20% by weight, preferably 7% to 17% by weight, more preferably 8% to 15% by weight, based on the rubber-modified vinyl (co)polymer B, of one or more elastomeric graft substrates having glass transition temperatures T_{g}<−50° C., preferably of <−60° C., particularly preferably <−70° C., containing at least 50% by weight, preferably at least 70% by weight, particularly preferably 100% by weight, based on B.2, of structural units derived from 1,3-butadiene,
   wherein the rubber-modified vinyl (co)polymer B contains
   (i) a disperse phase consisting of
      (i.1) rubber particles grafted with vinyl (co)polymer composed of structural units of B.1 and
      (i.2) vinyl (co)polymer likewise composed of structural units of B.1 enclosed in the rubber particles as a separate disperse phase and
   (ii) a rubber-free vinyl (co)polymer matrix consisting of structural units of B.1 which is not bonded to the rubber particles and is not enclosed in these rubber particles,

and wherein the disperse phase of (i) has a median diameter D50 measured by ultracentrifugation of 0.3 to 2.0 μm, preferably of 0.5 to 1.5 μm, in particular of 0.7 to 1.2.

Unless expressly stated otherwise in the present invention the glass transition temperature T_{g} is determined for all components by dynamic differential scanning calorimetry (DSC) according to DIN EN 61006 (1994 version) at a heating rate of 10 K/min with determination of Tg as the midpoint temperature (tangent method).

The rubber-modified vinyl (co)polymers of component B have a melt volume flow rate (MVR) measured according to ISO 1133 (2012 version) at 220° C. with a piston load of 10 kg of preferably 2 to 20 ml/10 min, particularly preferably 3 to 15 ml/10 min, especially 4 to 8 ml/10 min. If mixtures of two or more rubber-modified vinyl (co)polymers are employed as component B the preferred MVR ranges apply to the average of the MVR of the individual components weighted by the mass fractions of the components in the mixture.

Such rubber-modified vinyl (co)polymers B are produced by polymerization, preferably in a bulk polymerization process, of

B.1 80% to 95% by weight, preferably 83% to 93% by weight, particularly preferably 85% to 92% by weight, based on the rubber-modified vinyl (co)polymer B, of at least one vinyl monomer in the presence of

B.2 5% to 20% by weight, preferably 7% to 17% by weight, particularly preferably 8% to 15% by weight, based on the rubber-modified vinyl (co)polymer B, of one or more elastomeric graft substrates having glass transition temperatures <−50° C., preferably <−60° C., particularly preferably <−70° C., and containing at least 50% by weight, preferably at least 70% by weight, particularly preferably 100% by weight, based on B.2 of structural units derived from 1,3-butadiene.

The bulk polymerization reaction preferably used for producing the rubber-modified vinyl (co)polymer B comprises both the polymerization of the vinyl monomers of B.1 and a grafting of the thus formed vinyl (co)polymer onto the elastomeric graft substrate of B.2. Furthermore, in this reaction regime self-organization (phase separation) results in formation of a disperse phase (i) consisting of
(i.1) rubber particles grafted with vinyl (co)polymer composed of structural units of B.1 and
(i.2) vinyl (co)polymer likewise composed of structural units of B.1 enclosed in the rubber particles as a separate disperse phase,

wherein this rubber-containing phase (i) is in the form of a dispersion in a rubber-free vinyl (co)polymer matrix (ii) not bonded to the rubber particles and not enclosed in these rubber particles and consisting of structural units of B.1.

In contrast to the other vinyl (co)polymer proportions in the component B the rubber-free vinyl (co)polymer (ii) may be dissolved out using suitable solvents such as acetone for example.

The size of the disperse phase (i) in the thus produced rubber-modified vinyl (co)polymers B is adjusted via the conditions of the reaction regime such as temperature and the viscosity of the polymer resulting therefrom and also shear from stirring for example.

The median particle size D50 is the diameter with 50% by weight of the particles above it and 50% by weight below it. Unless expressly stated otherwise in the present invention it is determined for all components by ultracentrifuge measurement (W. Scholtan, H. Lange, Kolloid, Z. and Z. Polymere 250 (1972), 782-796).

The monomers B.1 are preferably mixtures consisting of

B.1.1 60 to 85 parts by weight, particularly preferably 65 to 80 parts by weight, more preferably 70 to 78 parts by weight, in each case based on the sum of B.1.1 and B.1.2 of styrene and

B.1.2 15 to 40 parts by weight, particularly preferably 20 to 35 parts by weight, more preferably 22 to 30 parts by weight, in each case based on the sum of B.1.1 and B.1.2 of acrylonitrile

and optionally B.1.3 0-10 parts by weight, preferably 0-7 parts by weight, more preferably 0-5 parts by weight, of methyl methacrylate or n-butyl acrylate in each case based on 100 parts by weight as the sum of B.1.1 and B.1.2.

In a further preferred embodiment the monomers B.1 are a mixture of 22 to 26 parts by weight of acrylonitrile and 74 to 78 parts by weight of styrene, which optionally can contain up to 10 parts by weight, particularly preferably up to 5 parts by weight, of n-butyl acrylate or methyl methacrylate, wherein the parts by weight of styrene and acrylonitrile sum to 100 parts by weight.

It is particularly preferable when B.1 is free from B.1.3, wherein the abovementioned preferred ranges apply to B.1.1 and B.1.2.

Preferred graft substrates B.2 are diene rubbers containing butadiene or mixtures of diene rubbers containing butadiene or copolymers of diene rubbers containing butadiene or mixtures thereof with further copolymerizable monomers (for example of B.1.1 and B.1.2).

A particularly preferred graft substrate B.2 is pure polybutadiene rubber. In a further preferred embodiment B.2 is styrene-butadiene block copolymer rubber.

Component B preferably has a polybutadiene content of 5% to 18% by weight, more preferably of 7% to 15% by weight, in particular of 8% to 13% by weight.

Particularly preferred rubber-modified vinyl (co)polymers of component B are bulk-polymerized ABS polymers as described for example in DE-A 2 035 390 (=U.S. Pat. No. 3,644,574 B) or in DE-A 2 248 242 (=GB-B 1 409 275), or in Ullmanns Enzyklopädie der Technischen Chemie, Vol. 19 (1980), p. 280 ff.

Component B may optionally contain further rubber-modified graft polymers of the components B.1 and B.2 produced by emulsion polymerization.

The proportion of these further graft polymers, based on the component B, is preferably less than 30% by weight, particularly preferably less than 15% by weight, and the component B especially contains no such further graft polymers.

The vinyl (co)polymer (ii) not chemically bonded to the rubber substrate(s) B.2 and not enclosed in the rubber particles may be formed as described above as a consequence of production in the polymerization of the graft polymers B. It is likewise possible for a portion of this vinyl (co)polymer (ii) not chemically bonded to the rubber substrate(s) B.2 and not enclosed in the rubber particles to be formed in the rubber-modified vinyl (co)polymer of component B as a consequence of production in the production thereof in the bulk polymerization process and for another portion to be polymerized separately and added to the component B as a constituent of the component B. In component B the proportion of the vinyl (co)polymer (ii), irrespective of origin, measured as the acetone-soluble proportion is preferably at least 50% by weight, particularly preferably at least 60% by weight, more preferably at least 70% by weight, based on component B.

In the rubber-modified vinyl (co)polymers of component B this vinyl (co)polymer (ii) has a weight-average molecular weight M_{W} of 70 to 250 kg/mol, preferably of 130 to 200 kg/mol, in particular of 150 to 180 kg/mol.

In the context of the present invention the weight-average molecular weight M_{W} of the vinyl (co)polymer (ii) in component B is measured by gel permeation chromatography (GPC) in tetrahydrofuran against a polystyrene standard.

The component B is preferably free from alkali metal, alkaline earth metal, ammonium or phosphonium salts of saturated fatty acids having 8 to 22 carbon atoms, resin acids, alkyl- and alkylarylsulfonic acids and fatty alcohol sulfates.

Component B preferably contains less than 100 ppm, particularly preferably less than 50 ppm, very particularly preferably less than 20 ppm, of ions of alkali metals and alkaline earth metals.

Rubber-modified vinyl (co)polymers suitable as component B are for example Magnum™ 3404, Magnum™ 3904, Magnum™ 8434 and Magnum™ 8391 from Trinseo.

### Component C

A polymer additive, a polymeric blend partner or a plurality of further polymer additives and/or polymeric blend partners may optionally be present as component C.

The polymer additives/polymeric blend partners are preferably selected from the group consisting of lubricants and mold release agents, stabilizers, colorants, compatibilizers, further impact modifiers distinct from component B, further polymeric constituents (for example functional blend partners) distinct from the components A to C and fillers and reinforcers.

In a preferred embodiment no fillers or reinforcers are present.

In a preferred embodiment at least one polymer additive selected from the group consisting of lubricants and mold release agents and stabilizers is employed as component C.

In a preferred embodiment at least one representative selected from the group consisting of sterically hindered phenols, organic phosphites and organic or inorganic Brönstedt acids is employed as a stabilizer.

In a preferred embodiment fatty acid esters, particularly preferably fatty acid esters of pentaerythritol or glycerol, are employed as lubricants and mold release agents.

In a particularly preferred embodiment at least one polymer additive selected from the group consisting of C8-C22 fatty acid esters of pentaerythritol, C8-C22 fatty acid esters of glycerol, tris(2,4-di-tert-butylphenyl)phosphite, 2,6-di-tert-butyl-4-(octadecanoxycarbonylethyl)phenol, tetrakis(2,4-di-tert-butylphenyl)-4,4-biphenyldiphosphonite, bis(2,4-di-tert-butylphenyl)pentaerythritol diphosphite and triethylene glycol bis[3-(3-tert-butyl-4-hydroxy-5-methylphenyl)propionate] is employed as component C.

In a further embodiment the component C contains no rubber-modified vinyl (co)polymer produced by emulsion polymerization.

The components A to C are to be selected such that they are permitted for use in plastics that are in contact with foodstuffs. The relevant regional regulatory conditions must also be met.

### Production of the Molding Compounds and Molded Bodies

Thermoplastic molding compounds are produced from the compositions according to the invention containing or consisting of the components A, B and C.

The thermoplastic molding compounds according to the invention may be produced for example when the respective constituents of the compositions are in familiar fashion mixed and melt-compounded and melt-extruded at temperatures of preferably 200° C. to 320° C., particularly preferably at 240° C. to 300° C., very particularly preferably at 260° C. to 290° C., in customary apparatuses such as internal kneaders, extruders and twin-screw extruders for example.

In the context of the present application this process is generally referred to as compounding.

The term “molding compound” is thus to be understood as meaning the product obtained when the constituents of the composition are melt-compounded and melt-extruded.

The mixing of the individual constituents of the compositions may be carried out in a known manner, either successively or simultaneously, either at about 20° C. (room temperature) or at a higher temperature. This means that for example some of the constituents may be added via the main intake of an extruder and the remaining constituents may be supplied subsequently in the compounding process via an ancillary extruder.

Molded bodies are produced from the molding compounds according to the invention, for example by injection molding, extrusion and blow molding processes. A further form of processing is the production of molded bodies by deep drawing from previously produced sheets or films.

The constituents of the composition may also be metered directly into an injection molding machine or into an extrusion apparatus and processed into molded bodies.

The articles according to the invention contain or consist of the described molded bodies.

In the articles according to the invention the molded bodies may be partially covered with other materials or joined to other materials. It is thus possible for example for the molded bodies to be reinforced with metals, glass, ceramics or other plastics or plastic composites for example, provided with handles made of other materials, or partially coated by methods familiar to those skilled in the art.

“Articles according to the invention” are thus to be understood as articles that merely consist of the molded bodies and likewise also articles that contain joined materials or coatings as described above in addition to the molded bodies.

When using the article the molded body consisting of the thermoplastic composition is partially or completely in direct contact with the fats, oils or fat-containing foodstuffs. This means that when using the article the foodstuff is in direct contact with the thermoplastic composition containing or consisting of the components A to C.

Further embodiments 1 to 27 of the present invention are described hereinbelow:

1. Article selected from the group consisting of containers for packaging, for serving, for storage and/or for transport of fats, oils or fat-containing foodstuffs, tools for consumption of fats, oils or fat-containing foodstuffs, tools for production, preparation, shaping and processing of fats, oils or fat-containing foodstuffs and parts of machines for production, preparation, shaping and processing of fats, oils or fat-containing foodstuffs containing or consisting of a molded body consisting of a thermoplastic composition, characterized in that the thermoplastic composition contains or consists of the following components:
A) aromatic polycarbonate,
B) rubber-modified vinyl (co)polymer composed of
   B.1) 80% to 95% by weight, based on the rubber-modified vinyl (co)polymer B, of structural units derived from at least one vinyl monomer and
   B.2) 5% to 20% by weight, based on the rubber-modified vinyl (co)polymer B, of one or more elastomeric graft substrates having glass transition temperatures <−50° C. and containing at least 50% by weight based on B.2 of structural units derived from 1,3-butadiene,
      wherein the rubber-modified vinyl (co)polymer B contains
      (i) a disperse phase consisting of
         (i.1) rubber particles grafted with vinyl (co)polymer composed of structural units of B.1 and
         (i.2) vinyl (co)polymer likewise composed of structural units of B.1 enclosed in the rubber particles as a separate disperse phase and
      (ii) (ii) a rubber-free vinyl (co)polymer matrix consisting of structural units of B.1 which is not bonded to the rubber particles and is not enclosed in these rubber particles,
   wherein the disperse phase of (i) has a median diameter D50 measured by ultracentrifugation of 0.3 to 2.0 μm,
C) optionally at least one further component selected from polymer additives and polymeric blend partners,

and wherein during use of the article the molded body is in direct contact with the fats, oils or fat-containing foodstuffs.

2. Article according to embodiment 1, wherein the article, the molded body and the thermoplastic composition meet the regulatory requirements for food contact applications in at least one country selected from the group consisting of the countries of the European Union, the countries of Europe which are not members of the European Union, The United States of America, Russia, China, Mexico, Japan, South Korea, Taiwan, Canada, Brazil and Thailand.

3. Article according to embodiment 1 or 2, wherein the molded body is suitable for contact with fats, oils or fat-containing foodstuffs having a temperature of greater than 30° C.

4. Article according to any of the preceding embodiments, wherein during its use the molded body is in contact with fats, oils or fat-containing foodstuffs having a temperature of greater than 30° C.

5. Article according to any of the preceding embodiments, wherein the molded body is a mold.

6. Article according to embodiment 5, wherein the mold is a chocolate mold.

7. Article according to any of the preceding embodiments, wherein component A is an aromatic polycarbonate based exclusively on bisphenol A.

8. Article according to any of the preceding embodiments, wherein component A has a weight-average molecular weight M_{W} (determined by gel permeation chromatography (GPC) in methylene chloride with a polycarbonate standard) of 24000 to 32000 g/mol.

9. Article according to any of the preceding embodiments, wherein the component B.1 is a mixture of structural units derived from styrene and acrylonitrile, optionally additionally containing structural units derived from butyl acrylate or methyl methacrylate, and the component B.2 is selected from at least one representative of the group consisting of polybutadiene rubber and styrene-butadiene (block) copolymer rubber.

10. Article according to embodiment 9, wherein the component B.1 is a mixture of structural units derived from styrene and acrylonitrile and the component B.2 is a pure polybutadiene rubber.

11. Article according to any of the preceding embodiments containing 85% to 92% by weight of B.1 and 8% to 15% by weight of B.2, in each case based on B.

12. Article according to any of the preceding embodiments, wherein the disperse phase according to (i) has a median diameter D50 measured by ultracentrifugation of 0.7 to 1.2 gm.

13. Article according to any of the preceding embodiments, wherein the component B has a polybutadiene content of 8% to 13% by weight.

14. Article according to any of the preceding embodiments, wherein the component B contains no rubber-modified vinyl (co)polymer produced by emulsion polymerization.

15. Article according to any of the preceding embodiments, wherein the component C contains no rubber-modified vinyl (co)polymer produced by emulsion polymerization.

16. Article according to any of the preceding embodiments, wherein the component B is free from alkali metal, alkaline earth metal, ammonium or phosphonium salts of saturated fatty acids having 8 to 22 carbon atoms, resin acids, alkyl- and alkylarylsulfonic acids and fatty alcohol sulfates.

17. Article according to any of the preceding embodiments, wherein the component B contains less than 20 ppm of ions of alkali metals and alkaline earth metals.

18. Article according to any of the preceding embodiments, wherein the component B is produced by bulk polymerization.

19. Article according to any of the preceding embodiments, wherein at least one polymer additive selected from the group consisting of C8-C22 fatty acid esters of pentaerythritol, C8-C22 fatty acid esters of glycerol, tris(2,4-di-tert-butylphenyl)phosphite, 2,6-di-tert-butyl-4-(octadecanoxycarbonylethyl)phenol, tetrakis(2,4-di-tert-butylphenyl)-4,4-biphenyldiphosphonite, bis(2,4-di-tert-butylphenyl)pentaerythritol diphosphite and triethylene glycol bis[3-(3-tert-butyl-4-hydroxy-5-methylphenyl)propionate] is employed as component C.

20. Article according to any of the preceding embodiments, wherein the thermoplastic composition contains

30-90% by weight of the component A,

10-70% by weight of the component B,

0-20% by weight of the component C.

21. Article according to any of the preceding embodiments, wherein the thermoplastic composition contains

50-80% by weight of the component A,

15-45% by weight of the component B,

0.5-5% by weight of the component C.

22. Article according to any of the preceding embodiments, wherein the thermoplastic composition contains

60-75% by weight of the component A,

24-39% by weight of the component B and

0.1-1% by weight of the component C.

23. Article according to any of the preceding embodiments, wherein the thermoplastic composition consists of the components A, B and C.

24. Process for producing a molded fat or fat-containing foodstuff comprising the steps of

a) heating the fat or fat-containing foodstuff above its melting point,

b) filling the molten fat or fat-containing foodstuff into an article according to any of the preceding embodiments 5 to 23,

c) cooling the fat or fat-containing foodstuff below its melting point and

d) demolding the molding produced from the fat or fat-containing foodstuff in process steps a) to c) from the article.

25. Use of a thermoplastic composition containing or consisting of
A) aromatic polycarbonate,
B) rubber-modified vinyl (co)polymer composed of
B.1) 80% to 95% by weight, based on the rubber-modified vinyl (co)polymer B, of structural units derived from at least one vinyl monomer and
B.2) 5% to 20% by weight, based on the rubber-modified vinyl (co)polymer B, of one or more elastomeric graft substrates having glass transition temperatures <−50° C. and containing at least 50% by weight based on B.2 of structural units derived from 1,3-butadiene,
   wherein the rubber-modified vinyl (co)polymer B contains
   (i) a disperse phase consisting of
      (i.1) rubber particles grafted with vinyl (co)polymer composed of structural units of B.1 and
      (i.2) vinyl (co)polymer likewise composed of structural units of B.1 enclosed in the rubber particles as a separate disperse phase and
   (ii) a rubber-free vinyl (co)polymer matrix consisting of structural units of B.1 which is not bonded to the rubber particles and is not enclosed in these rubber particles,
   wherein the disperse phase of (i) has a median diameter D50 measured by ultracentrifugation of 0.3 to 2.0 μm,

C) optionally at least one further component selected from polymer additives and polymeric blend partners for producing a molded body as part of an article selected from the group consisting of containers for packaging, for serving, for storage and/or for transport of fats, oils or fat-containing foodstuffs, tools for consumption of fats, oils or fat-containing foodstuffs, tools for production, preparation, shaping and processing of fats, oils or fat-containing foodstuffs and parts of machines for production, preparation, shaping and processing of fats, oils or fat-containing foodstuffs,
wherein during use of the article the molded body is in direct contact with the fats, oils or fat-containing foodstuffs.

26. Use according to embodiment 25, wherein the composition contains

60-75% by weight of the component A,

24-39% by weight of the component B and

0.1-1% by weight of the component C,

and wherein the component B.1 is a mixture of styrene and acrylonitrile and the component B.2 is a pure polybutadiene rubber,

and wherein the component B is free from alkali metal, alkaline earth metal, ammonium or phosphonium salts of saturated fatty acids having 8 to 22 carbon atoms, resin acids, alkyl- and alkylarylsulfonic acids and fatty alcohol sulfates,

and wherein the component B contains less than 20 ppm of ions of alkali metals and alkaline earth metals,

and wherein at least one polymer additive selected from the group consisting of C8-C22 fatty acid esters of pentaerythritol, C8-C22 fatty acid esters of glycerol, tris(2,4-di-tert-butylphenyl)phosphite, 2,6-di-tert-butyl-4-(octadecanoxycarbonylethyl)phenol, tetrakis(2,4-di-tert-butylphenyl)-4,4-biphenyldiphosphonite, bis(2,4-di-tert-butylphenyl)pentaerythritol diphosphite and triethylene glycol bis[3-(3-tert-butyl-4-hydroxy-5-methylphenyl)propionate] is employed as component C.

27. Use of an article containing or consisting of a molded body consisting of a thermoplastic composition containing or consisting of
A) aromatic polycarbonate,
B) rubber-modified vinyl (co)polymer composed of
B.1) 80% to 95% by weight, based on the rubber-modified vinyl (co)polymer B, of structural units derived from at least one vinyl monomer and
B.2) 5% to 20% by weight, based on the rubber-modified vinyl (co)polymer B, of one or more elastomeric graft substrates having glass transition temperatures <−50° C. and containing at least 50% by weight based on B.2 of structural units derived from 1,3-butadiene,
   wherein the rubber-modified vinyl (co)polymer B contains
   (i) a disperse phase consisting of
      (i.1) rubber particles grafted with vinyl (co)polymer composed of structural units of B.1 and
      (i.2) vinyl (co)polymer likewise composed of structural units of B.1 enclosed in the rubber particles as a separate disperse phase and
   (ii) (ii)a rubber-free vinyl (co)polymer matrix consisting of structural units of B.1 which is not bonded to the rubber particles and is not enclosed in these rubber particles,
   wherein the disperse phase of (i) has a median diameter D50 measured by ultracentrifugation of 0.3 to 2.0 μm,
C) optionally at least one further component selected from polymer additives and polymeric blend partners

for transport, packaging, storage, treatment, production, preparation, processing and shaping of fats, oils or fat-containing foodstuffs, wherein the molded body is in direct contact with the fats, oils or fat-containing foodstuffs.

### EXAMPLES

### Component A1

Linear polycarbonate based on bisphenol A having a weight-average molecular weight M_{W} of 28 000 g/mol (determined by GPC at room temperature in methylene chloride against a BPA-PC standard).

### Component A2

Linear polycarbonate based on bisphenol A having a weight-average molecular weight M_{W} of 25 000 g/mol (determined by GPC at room temperature in methylene chloride against a BPA-PC standard).

### Component A3

Linear polycarbonate based on bisphenol A having a weight-average molecular weight M_{W} of 19 000 g/mol (determined by GPC at room temperature in methylene chloride against a BPA-PC standard).

### Component B-1

Acrylonitrile-butadiene-styrene (ABS) polymer produced in a bulk polymerization process which contains a disperse phase composed of polybutadiene-containing rubber particles which are grafted with styrene-acrylonitrile copolymer and contain enclosed styrene-acrylonitrile copolymer as a separate disperse phase and a styrene-acrylonitrile copolymer matrix which is not chemically bonded to the rubber particles and not enclosed in the rubber particles. Component B has an A:B:S ratio of 23:10:67% by weight and a gel content, determined as the acetone-insoluble proportion, of 20% by weight. The acetone-soluble proportion of the styrene-acrylonitrile copolymer in component B is 80% by weight based on the component B and has a weight-average molecular weight M_{W} (measured by GPC in tetrahydrofuran as the solvent with a polystyrene standard) of 165 kg/mol. The median particle size of the disperse phase D50, measured by ultracentrifugation, is 0.85 μm. The melt volume flow rate (MVR) of the component B1, measured according to ISO 1133 (2012 version) at 220° C. with a piston load of 10 kg, is 6.7 ml/10 min.

### Component B-2

Precompound composed of 50% by weight of an ABS-type graft polymer produced in an emulsion polymerization process having an A:B:S ratio of 12:56:32% by weight and 50% by weight of a styrene-acrylonitrile copolymer produced in a bulk polymerization process having a styrene-acrylonitrile ratio of 72:28% by weight and having a weight-average molecular weight Mw of 100 kg/mol measured by GPC in dimethylformamide at 20° C. with a polystyrene standard.

### Component C1

Pentaerythritol tetrastearate

### Component C2

Irganox™ 1076 (BASF, Ludwigshafen, Germany)

2,6-di-tert-butyl-4-(octadecanoxycarbonylethyl)phenol

### Production and Testing of the Molding Compounds According to the Invention

The mixing of the components was carried out under good manufacturing practice (GMP) conditions in a Werner & Pfleiderer ZSK-70 twin-screw extruder at a melt temperature of 260° C. and with application of a reduced pressure of 100 mbar (absolute).

The molded bodies were produced at melt temperatures of 260° C. or 290° C. and in both cases at a mold temperature of 80° C. in an Arburg 270 E injection molding machine.

The melt volume flow rate (MVR) was determined according to ISO 1133 (2012 version) at 260° C. with a piston load of 5 kg after a dwell time of 5 minutes.

IZOD notched impact strength was determined at 23° C. according to ISO 180-1A (1982 version) on each of ten test specimens measuring 80 mm×10 mm×4 mm and is reported in table 1 as the average of ten individual measurements. The test specimens were produced at a melt temperature of 260° C.

Vicat B/120 as a measure of heat resistance was determined according to ISO 306 (2013 version) on test specimens measuring 80 mm×10 mm×4 mm with a piston load of 50 N and a heating rate of 120° C./h. The test specimens were produced at a melt temperature of 260° C.

Melt viscosity as a measure of melt flowability was determined according to ISO 11443 (2014 version) at temperatures of 260° C. or 300° C. and in both cases at a shear rate of 1000 s⁻¹.

The stress cracking resistance (ESC) in rapeseed oil was used as a measure of the stability of the molded bodies in contact with fats, oils and fat-containing foodstuffs. The time until stress cracking-induced fracture failure at room temperature of a test specimen injection-molded under the above-described conditions and having dimensions of 80 mm×40 mm×4 mm was determined by subjecting the test specimen to 2.4% outer fiber strain by means of a clamping template and completely immersing it into the rapeseed oil. This measurement was carried out according to DIN EN ISO 22088 (2006 version).

The relative percentage change in melt flow rate MVR (delta MVR) was used as a measure of the hydrolysis resistance of the molded bodies.

delta MVR=100×(MVR_{after storage}−MVR_{before storage})/MVR_{before storage},

wherein the MVR was measured according to ISO 1133 (2012 version) at 260° C. with a piston load of 5 kg before and after seven days of storage at 95° C. and 100% relative humidity. In the present case the storage was performed on pellets.

Surface gloss was measured in reflection at viewing angles of 20° and 60° with a Haze-Gloss instrument from BYK-Gardner GmbH (Geretsried, Germany) according to DIN 67530 (1982 version) on test specimens having dimensions of 60 mm×40 mm×4 mm. An injection mold polished to a high shine was used to produce the test specimens. The test specimens were produced at a melt temperature of 260° C.

The tensile elastic modulus as a measure for stiffness was determined at room temperature according to ISO 527 (1996 version). The test specimens were produced at a melt temperature of 260° C.

According to COMMISSION REGULATION (EU) No 10/2011 of Jan. 14, 2011 concerning materials and objects made of plastic which are intended to come into contact with foodstuffs, total migration is to be understood as meaning the amount of non-volatile substances emitted from a material or article into food simulants. Total migration was determined according to DIN EN 1186-14 (2002 version) on test bars having dimensions of 80 mm×10 mm×4 mm in respective two-hour complete contact with a) isooctane and b) in ethanol (95% by volume) as food simulants at 70° C. To this end such a test bar having a total surface area of 0.16 dm² was in each case completely immersed in 37 ml of the food simulant. The test specimens were produced at a melt temperature of 260° C.

To simulate the influence of polycarbonate compositions on the constitution of different foodstuffs with which molded bodies produced from these polycarbonates compositions are in direct contact upon use of articles containing such molded bodies, 100 g of pellets of the compositions 1 and V5 were stored for 2 days at room temperature (RT) in 100 g in each case of different food simulant media. After storage the haze value (clouding) according to ISO 14792 (containing 1999 version) of the decanted media employed was analyzed using a Perkin Elmer Lambda 950 instrument. A higher haze (clouding) value in the same medium points to increased migration from the pellets into the medium and thus indicates increased influencing of the foodstuff constitution which is not desired in the food contact application. The employed media simulate different types of foodstuffs.

A similar test was used to simulate migration characteristics under conditions such as are encountered in the production of a molded fat or fat-containing foodstuff—such as for instance a chocolate molding—using a mold.

To this end 30 g of pellets of samples 1, V2 and V5 were in each case stored for 2 hours with stirring in 30 g of isooctane heated to 70° C. in a glass flask, the isooctane was then decanted and the haze (clouding) value of the decanted food simulant according to ISO 14792 (1999 version) was analyzed using a Perkin Elmer Lambda 950 instrument.

TABLE 1
Compositions and properties thereof

| | 1 | V2 | V3 | V4 |
|---|---|---|---|---|
| Components | | | | |
| [parts by weight] | | | | |
| A1 | 70 | 100 | | |
| A2 | | | 100 | |
| A3 | | | | 100 |
| B-1 | 30 | | | |
| C1 | 0.3 | | | |
| C2 | 0.1 | | | |
| Properties | | | | |
| ESC (time until fracture) [h] melt | >24 | >24 | | <0.01 |
| temperature in the injection mold: 260° C. | | | | |
| ESC (time until fracture) [h] melt | | 2.5 | 0.5 | |
| temperature in the injection mold: 290° C. | | | | |
| Notched impact strength [kJ/m²] | 55 | 68 | | |
| Vicat B/120 [° C.] | 133 | 146 | | |
| MVR [ml/10 min] | 15 | 14 | | |
| Melt viscosity (260° C.) [Pa s] | 243 | 735 | 546 | 260 |
| Melt viscosity (300° C.) [Pa s] | | 241 | 205 | |
| Tensile elastic modulus [MPa] | 2316 | 2324 | | |
| Hydrolysis resistance (delta MVR) [%] | 8 | | | |
| Gloss (20°) | 43 | 201 | | |
| Gloss (60°) | 84 | 177 | | |
| Total migration in isooctane | <10 mg/dm² | not determined | | |
| Total migration in ethanol (95%) | <10 mg/dm² | not determined | | |

The data in table 1 show that the inventive composition 1 solves the technical problem. Said composition features an improved melt flowability compared to pure polycarbonate having a molecular weight corresponding to that of component A in the inventive composition (V2). The produced articles exhibit good resistance to oil and a low gloss coupled with mechanical properties similar to an article made of the pure polycarbonate. Increasing the temperature during processing to achieve a melt flowability in injection molding similar to that in the composition according to the invention results in a significantly poorer resistance to stress cracking in oil of the thus produced articles. Compared to pure polycarbonate having a lower molecular weight which has a similar melt flowability to the inventive composition (V4), the inventive composition exhibits a markedly improved resistance to stress cracking in oil of the articles produced under comparable conditions by injection molding.

TABLE 2
Compositions and properties thereof

| | 1 | V2 | V5 |
|---|---|---|---|
| Components | | | |
| [parts by weight] | | | |
| A1 | 70 | 100 | 70 |
| B-1 | 30 | | |
| B-2 | | | 30 |
| C1 | 0.3 | | 0.3 |
| C2 | 0.1 | | 0.1 |
| Properties | | | |
| Haze [%] | 2.68 | | 0.13 |
| Mixture of 90% by volume of water and 10% by volume | | | |
| of ethanol, 2 days at RT | | | |
| Haze [%] | 5.53 | | 0.21 |
| Mixture of 50% by volume of water and 50% by volume | | | |
| of ethanol, 2 days at RT | | | |
| Haze [%] | 0.44 | | 0.27 |
| Mixture of 97% by weight of water and 3% by weight of | | | |
| acetic acid, 2 days at RT | | | |
| Haze [%] | 0.19 | | 0.31 |
| Isooctane, 2 days at RT | | | |
| Haze [%] | 0.34 | 0.34 | 0.39 |
| Isooctane, 2 hours at 70° C. | | | |

The data in table 2 show that the compositions 1 and V5 influence the constitution of the different food simulant media in markedly different ways although both compositions are comparable in terms of the proportions of polycarbonate, ABS and additives. The haze values for the aqueous food simulants are markedly lower after contact with the composition V5 than after contact with the composition 1, i.e. the constitution of these aqueous simulants is influenced by the composition V5 to a markedly lesser extent than by the inventive composition 1. By contrast, in isooctane which serves as a simulant for fat-containing foodstuffs clouding is markedly lower after contact with the inventive composition 1 than after contact with the composition V5. It is apparent from the foregoing that composition 1 is more suitable for use in contact with fat-containing foodstuffs while the composition V5 is more advantageous for contact with water-containing foodstuffs such as coffee for instance. Also at higher temperatures and shorter contact times between the food simulant and the pellets with isooctane as the food simulant for fats and fat-containing foodstuffs a lower clouding (haze) is observed with the inventive composition 1 than for V5. This also suggests better suitability for use in the production of molded fats and fat-containing foodstuffs, such as chocolate moldings. While composition V2 exhibits equally good characteristics in this regard as composition 1 it has the disadvantage, shown in table 1, of a markedly higher melt viscosity and an undesirably high gloss for use in the production of chocolate molds.

1-15. (canceled)

16. A thermoplastic molded article for food contact applications comprising:
A) aromatic polycarbonate,
B) rubber-modified vinyl (co)polymer comprising:
B.1) 80% to 95% by weight, based on the rubber-modified vinyl (co)polymer B, of structural units derived from at least one vinyl monomer, and
B.2) 5% to 20% by weight, based on the rubber-modified vinyl (co)polymer B, of one or more elastomeric graft substrates having glass transition temperatures <−50° C. and containing at least 50% by weight based on B.2 of structural units derived from 1,3-butadiene,
wherein the rubber-modified vinyl (co)polymer B contains
(i) a disperse phase consisting of
(i.1) rubber particles grafted with vinyl (co)polymer composed of structural units of B.1, and
(i.2) vinyl (co)polymer likewise composed of structural units of B.1 enclosed in the rubber particles as a separate disperse phase, and
(ii) a rubber-free vinyl (co)polymer matrix consisting of structural units of B.1 which is not bonded to the rubber particles and is not enclosed in these rubber particles,
wherein the disperse phase of (i) has a median diameter D50 measured by ultracentrifugation of 0.3 to 2.0 μm.

17. The article of claim 16, wherein component A is an aromatic polycarbonate based exclusively on bisphenol A.

18. The article of claim 16, wherein component B.1 is a mixture of structural units derived from styrene and acrylonitrile.

19. The article of claim 16, wherein component B.1 further comprises additional structural units derived from butyl acrylate or methyl methacrylate.

20. The article of claim 16, wherein component B.2 is polybutadiene rubber or styrene-butadiene (block) copolymer rubber.

21. The article of claim 16, wherein component B is free from alkali metal, alkaline earth metal, ammonium or phosphonium salts of saturated fatty acids having 8 to 22 carbon atoms, resin acids, alkyl- and alkylarylsulfonic acids and fatty alcohol sulfates.

22. The article of claim 16, wherein the component B contains less than 20 ppm of ions of alkali metals and alkaline earth metals.

23. The article of claim 16, further comprising one polymer additive selected from the group consisting of C8-C22 fatty acid esters of pentaerythritol, C8-C22 fatty acid esters of glycerol, tris(2,4-di-tert-butylphenyl)phosphite, 2,6-di-tert-butyl-4-(octadecanoxycarbonylethyl)phenol, tetrakis(2,4-di-tert-butylphenyl)-4,4-biphenyldiphosphonite, bis(2,4-di-tert-butylphenyl)pentaerythritol diphosphite and triethylene glycol bis[3-(3-tert-butyl-4-hydroxy-5-methylphenyl)propionate].

24. The article of claim 16, wherein the thermoplastic composition comprises
60-75% by weight of the component A,
24-39% by weight of the component B and
0.1-1% by weight of a polymer additive or a polymeric blend partner.

25. The article of claim 16, wherein the article is a container for packaging, for serving, for storage and/or for transport of fats, oils or fat-containing foodstuffs; a tool for consumption of fats, oils or fat-containing foodstuffs; a tool for production, preparation, shaping and processing of fats, oils or fat-containing foodstuffs; or a part of a machine for the production, preparation, shaping or processing of fats, oils or fat-containing foodstuffs.

26. The article of claim 16, wherein the article is a mold.

27. The article of claim 26, wherein the article is a chocolate mold.

28. A process for producing a molded fat or fat-containing foodstuff, the process comprising the steps of:
a) heating the fat or fat-containing foodstuff above its melting point,
b) filling the molten fat or fat-containing foodstuff into an article of claim 26,
c) cooling the fat or fat-containing foodstuff below its melting point and
d) demolding the molding produced from the fat or fat-containing foodstuff in process steps a) to c) from the article.
